(19) United States
(12) Patent Application Publication
(10) Pub. No.: US 2009/0200164 A1
(43) Pub. Date: Aug. 13, 2009

(54) GAS SENSOR

(75) Inventors: Takaya Yoshikawa, Aichi (JP); Masaru Kondo, Aichi (JP); Hiroshi Isomura, Aichi (JP); Hisaharu Nishio, Aichi (JP); Tomohiro Tajima, Aichi (JP)

Correspondence Address: KUSNER & JAFFE;HIGHLAND PLACE SUITE 310, 6151 WILSON MILLS ROAD, HIGHLAND HEIGHTS, OH, 44143, US

(73) Assignee: NGK Spark Plug Co., Ltd.

(21) Appl. No.: 12/364,087

(22) Filed: Feb. 2, 2009

(30) Foreign Application Priority Data
Feb. 8, 2008 (JP) JP 2008-029347
Apr. 2, 2008 (JP) JP 2008-096404

(51) Int. Cl. G01N 27/26

(52) U.S. Cl. 204/406

(57) ABSTRACT

A gas sensor includes a plate-like sensor element having solid electrolyte layers; a circuit board having a processing circuit for processing an output signal from the sensor element; terminals connected to the sensor element and to the circuit board and serving as electric junctions therebetween; and a metallic casing which encloses the sensor element, the circuit board, and the terminals and has attachment portions for attachment to an external object. The attachment portions are attached to an inlet pipe at a position located downstream of an EGR gas inlet or to a cylinder head.

### FIELD OF THE INVENTION

The present invention relates to a gas sensor.

### BACKGROUND OF THE INVENTION

Japanese Patent Application Laid-Open (kokai) No. 2007-139749) discloses a gas sensor disposed in an exhaust path of an automobile engine that is adapted to detect the concentration of oxygen contained in exhaust gas for utilization in combustion control of the engine. The oxygen sensor includes a tubular metallic shell and a plate-like sensor element, which is held in the metallic shell. The sensor element has a structure in which a detection element having solid electrolyte layers and electrodes and a heater having a heat-generating element and electrodes are laminated together. The sensor element extends in its longitudinal direction and has a detecting portion provided at its one longitudinal end region for exposure to a gas-to-be-measured. An electrode terminal portion is provided at its other longitudinal end region for electrical connections through electrodes and lead portions.

The electrode terminal portion is connected to an analog signal line, which is led into the oxygen sensor from outside. The end of the analog signal line is connected to an electronic control unit (hereinafter, referred to as the “ECU”). A sensor signal, which varies with an electric characteristic of the sensor element, is output to the ECU through the analog signal line. In the ECU, an analog-to-digital converter converts the input analog sensor signal to a digital signal. The digital signal then undergoes processing for detection of variation in oxygen concentration. Also, the ECU has a heater control circuit for controlling the amount of supply of power to the heater.

The above-mentioned ECU includes processing means associated with the oxygen sensor and includes the analog-to-digital converter and the heater control circuit. Thus, the ECU must be designed to secure therein an installation space for the processing means. This involves a problem of limiting the degree of freedom of design of the ECU and a problem of restricting the mode of use of the ECU. Particularly, in the case where a large number of components are to be mounted in the ECU, difficulty is encountered in securing an installation space for the processing means associated with the oxygen sensor, so that time is consumed in study of layout.

Also, since the sensor signal is sent from the sensor element to the ECU through the analog signal line, the sensor signal is susceptible to electric noise during transmission. Further, in this case, if the processing means associated with the oxygen sensor is not disposed in a sufficiently shielded condition within the ECU, electric noise may deteriorate electric reliability in conversion of the analog sensor signal to a digital signal.

### SUMMARY OF THE INVENTION

The present invention has been conceived in view of the above-mentioned conventional circumstances. An object of the invention is to provide a gas sensor which enhances the degree of freedom of design and versatility of the ECU and is less susceptible to electric noise.

In accordance with the present invention, there is provided a gas sensor comprised of a sensor element comprising a solid electrolyte layer having a pair of electrodes formed on the solid electrolyte layer, and having a detecting portion for detecting a gas-to-be-measured; a circuit board on which is mounted processing means for processing an output signal from the sensor element; a terminal serving as an electric junction between the detecting portion of the sensor element and the processing means of the circuit board; and a casing which is made of metal and which houses, in an integrated condition, the sensor element, the circuit board, and the terminal, and has an attachment portion for attachment to an external object.

In the gas sensor of the present invention, the metallic casing houses the sensor element, and the circuit board on which is mounted the processing means for processing an output signal from the sensor element. This eliminates the need to dispose the processing means within an ECU of a vehicle, thereby enhancing the degree of freedom of design and versatility of the ECU.

In addition to the metallic casing providing shielding for the sensor element, the circuit board, and the terminal, an analog signal line, which conventionally is laid between the sensor element and the ECU, is not employed. This provides a structure that is less susceptible to electric noise, thereby improving electrical reliability.

Therefore, the gas sensor enhances the degree of freedom of design and versatility of the ECU and is less susceptible to electric noise.

Preferably, in the gas sensor of the present invention, the detecting portion is located on a first-end side of the sensor element with respect to a longitudinal direction of the sensor element; the circuit board is located on a second-end side of the detecting portion opposite the first-end side with respect to the longitudinal direction; the circuit board is disposed along a direction generally perpendicular to the longitudinal direction of the sensor element; and the casing has a detecting-portion housing which houses the detecting portion, and a circuit-board housing which houses the circuit board and where the attachment portion is provided.

When the above-configured gas sensor is attached to a flow path through which a gas-to-be-measured flows, the detecting-portion housing, which is located on the first-end side of the sensor element, can be inserted deep into the flow path. Thus, the gas-to-be-measured can be accurately detected. Additionally, since the circuit board is disposed along a direction substantially perpendicular to the longitudinal direction of the sensor element, the circuit-board housing, which houses the circuit board and is attached to the exterior of the flow path, is low in height. Therefore, the degree of freedom of design for an engine and the like can be enhanced.

Preferably, a wall of the detecting-portion housing is configured such that a portion of the wall facing an upstream side of a flow path through which the gas-to-be-measured flows is blind, whereas a portion of the wall facing a downstream side of the flow path has a gas communication hole for allowing the gas-to-be-measured to come into contact with the detecting portion of the sensor element. This prevents entry, into the casing, of foreign matter, such as water, oil, and soot, contained in the gas-to-be-measured flowing through the flow path, which could otherwise result in interference of the foreign matter with the wall surface of the detecting-portion housing. Therefore, the configuration can prevent the occurrence of a problem caused by adhesion of such foreign matter to the sensor element. Meanwhile, the gas-to-be-measured is introduced into the casing through the gas communication hole located on the downstream side of the flow path and comes into contact with the detecting portion of the sensor element. Therefore, the gas-to-be-measured can be detected with good accuracy.

More preferably, the attachment portion has an improper-attachment prevention structure functioning such that, when the attachment portion is disposed with the gas communication hole facing the downstream side of the flow path, attachment of the attachment portion is enabled, whereas, when the attachment portion is disposed with the gas communication hole facing the upstream side of the flow path, attachment of the attachment portion is disabled. When attachment of the attachment portion is enabled, the communication hole is oriented in a proper direction, so that the gas-to-be-measured is properly introduced through the communication hole and measured properly. When the communication hole is improperly oriented toward the upstream side of the flow path, attachment of the attachment portion is disabled, thereby reliably preventing adhesion of foreign matter, such as water, oil, and soot, to the detecting portion of the sensor element.

Preferably, in the gas sensor of the present invention, the sensor element has a heater for heating the detecting portion, and the processing means is disposed on a surface of the circuit board facing away from the sensor element. By virtue of this configuration, the processing means of the circuit board is disposed apart from the heater, thereby preventing heat generated by the heater from affecting the processing means.

Preferably, the sensor element has a heater for heating the detecting portion; the circuit board has a terminal insertion hole through which the terminal is inserted; and the processing means and the terminal are electrically connected to each other on the surface of the circuit board facing away from the sensor element. By virtue of this configuration, the connection between the terminal and the processing means is disposed apart from the heater, thereby preventing heat generated by the heater from affecting the connection between the terminal and the processing means.

Preferably, the sensor element has a heater for heating the detecting portion, and a heat transfer section for transferring heat from the heater to the casing is provided in a clearance between the sensor element and the casing. The clearance being located near the second-end side of the detecting portion. In this manner, heat from the heater is released to the exterior of the casing via the heat transfer section and the casing, thereby effectively preventing heat generated by the heater from affecting the connection between the sensor element and the terminal, the connection between the terminal and the circuit board, and the processing means.

Preferably, the heat transfer section is of alumina. While exhibiting excellent thermal conductivity, alumina is electrically nonconductive; thus, the above-mentioned effect can be reliably provided without impairment of functions of the gas sensor.

Furthermore, preferably, a seal section is provided in a clearance between the casing and the sensor element. The clearance is located on the second-end side of the heat transfer section, so as to prevent passage of water through the clearance. By virtue of this configuration, the sensor element is airtightly sealed in relation to the circuit board, thereby preventing the movement of water from the detecting-portion housing to the circuit-board housing and thus preventing contact of water with the circuit board. Also, the clearance between the casing and the sensor element which the seal section fills is located on the second-end side of the heat transfer section. Thus, by virtue of the heat transfer section, the temperature of the seal section is unlikely to increase, so that the seal section is unlikely to deteriorate.

Furthermore, the circuit-board housing preferably has a vent hole extending between the interior and the exterior of the circuit-board housing. A filter having air permeability and resistance to passage of water is provided in such a manner as to cover the vent hole. If water which has entered the circuit-board housing from outside is evaporated into water vapor, the water vapor is discharged to the exterior of the circuit-board housing through the filter. Thus, the interior of the circuit-board housing does not become humid, thereby preventing the occurrence of a problem in the processing means of the circuit board.

Meanwhile, in recent years, studies have been conducted on a method of controlling combustion in an engine on the basis of the oxygen concentration of an atmosphere flowing through an intake path of the engine. The intake path is lower in temperature than a conventional exhaust pipe. Thus, by means of the detecting portion of the gas sensor of the present invention being disposed within the intake path, the following advantages are yielded. Thermal influence on the connection between the sensor element and the terminal, on the connection between the terminal and the circuit board, and on the processing means can be lessened, thereby protecting the connections and the processing means from thermal influence; the degree of freedom of design and versatility of the ECU can be enhanced; and susceptibility to electric noise can be lessened. Herein, the term “intake path” encompasses an intake pipe and an intake port of a cylinder head. Also, the term “exhaust path,” which will be mentioned later, encompasses an exhaust pipe and an exhaust port of the cylinder head.

Particularly, an EGR gas inlet may open into the intake path for introducing an EGR gas into the intake path. In this case, more preferably, the detecting portion is disposed downstream of the EGR gas inlet. This enables the sensor element to detect a specific gas (gas-to-be-measured) contained in a mixture of the EGR gas and an intake gas, whereby the combustion in the engine can be controlled with good accuracy.

Also, in order to enhance the degree of freedom of design for an engine and its periphery, studies have been conducted on a structure in which a gas sensor is mounted on a cylinder head of the engine. Since the intake path or the exhaust path of such a cylinder head is lower in temperature than a conventional exhaust pipe, the detecting portion of the gas sensor of the present invention is disposed within the intake path of the cylinder head or within the exhaust path of the cylinder head. This can lessen thermal influence on the connection between the sensor element and the terminal, on the connection between the terminal and the circuit board, and on the processing means to thereby protect the connections and the processing means from thermal influence. Such an arrangement can also enhance the degree of freedom of design and versatility of the ECU and can implement less susceptibility to electric noise. In this case, the attachment portion of the casing can be attached to the intake path of the cylinder head or to the exhaust path of the cylinder head.

Furthermore, the circuit-board housing is preferably formed of an aluminum-based or copper-based metallic material. Since the distance between a heat source and the circuit board (the processing means mounted on the circuit board) becomes shorter than a conventional one, the circuit board becomes more susceptible to thermal influence. However, since the circuit-board housing is formed of an aluminum-based or copper-based metallic material, heat transferred to the circuit-board housing is quickly released to the exterior of the circuit-board housing, thereby limiting thermal influence on the circuit board.

The aluminum-based metallic material can be aluminum or an aluminum alloy. The copper-based metallic material can be copper or a copper alloy. For example, duralumin, aluminum die casting alloys, brass, and bronze are preferred materials. Particularly, aluminum die casting alloys are preferred, since aluminum die cast alloys can be readily die-cast and exhibits good machinability.

Applications of the gas sensor of the present invention include gas sensors of engines, particularly those of diesel engines (oxygen sensors, hydrocarbon sensors, and NOₓ sensors), and gas sensors of various devices.

### BRIEF DESCRIPTION OF THE DRAWINGS

FIG. 1 is a sectional view of a gas sensor according to an embodiment of the present invention;

FIG. 2 is a plan view of the gas sensor;

FIG. 3 is a perspective view showing a state before a sensor element is assembled into a detecting-portion housing;

FIG. 4 is a perspective view showing a state before the detecting-portion housing is assembled to a circuit-board housing;

FIG. 5 is an exploded perspective view of the gas sensor;

FIG. 6 is a perspective view showing a state before the gas sensor is mounted on a mounting surface;

FIG. 7 is a sectional view showing essential portions of the gas sensor and illustrating a state in which gas comes in contact with a detecting portion;

FIG. 8 is an exploded perspective view of the sensor element;

FIG. 9 is a schematic view of a mounting mode 1 in which the gas sensor is mounted on an intake pipe; and

FIG. 10 is a schematic view of a mounting mode 2 in which the gas sensor is mounted on a cylinder head.

### DETAILED DESCRIPTION OF PREFERRED EMBODIMENT

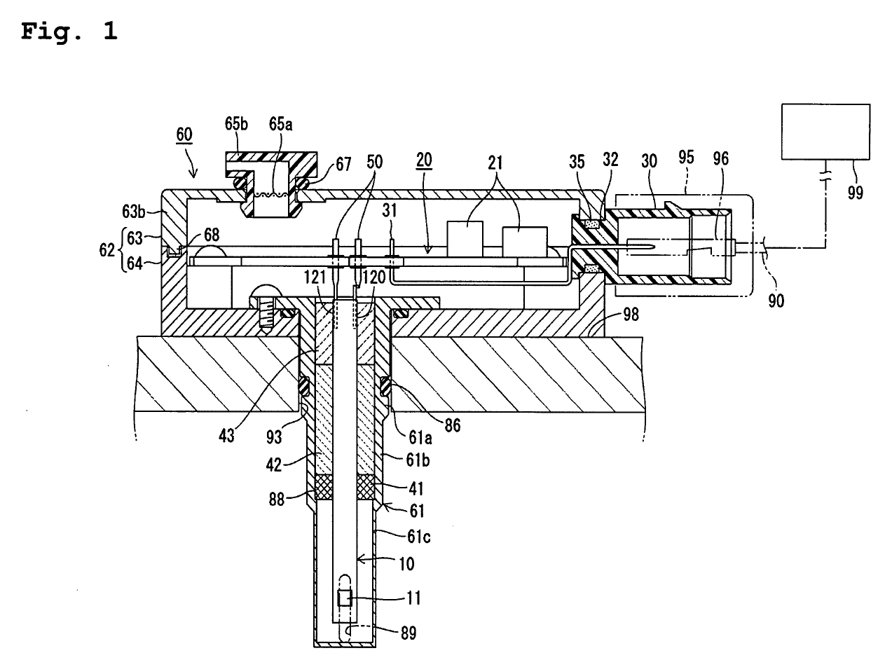

A gas sensor according to an embodiment of the present invention will next be described in detail with reference to the drawings. As shown in FIG. 1, the gas sensor includes a sensor element 10, a circuit board 20, terminals 50, and a casing 60, which collectively houses the components.

The sensor element 10 assumes the form of a plate extending in the longitudinal direction thereof and has a detecting portion 11 formed at a forward end (on a first-end side with respect to the longitudinal direction; specifically, on a side toward its lower end in FIG. 1) and electrode terminal portions 120 and 121 formed on front and back surfaces of the sensor element 10 at the upper end thereof.

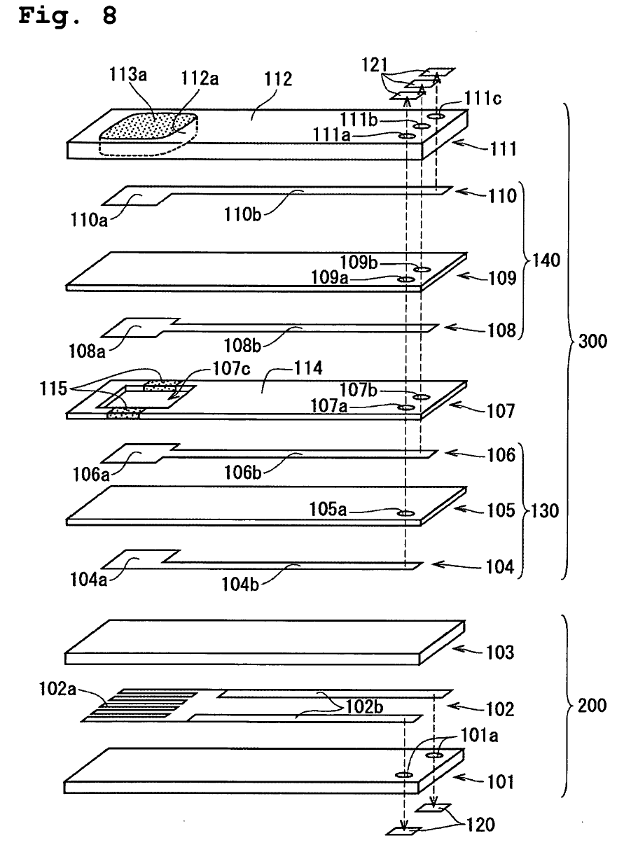

As shown in FIG. 8, the sensor element 10 has a structure in which a detection element 300 and a heater 200 are laminated together. The detection element 300 has a structure in which an oxygen-concentration detection cell 130 and an oxygen pump cell 140 are laminated together.

The heater 200 has a first substrate 101 and a second substrate 103, which predominantly contain alumina; and a heat-generating element 102, which is sandwiched between the first substrate 101 and the second substrate 103 and predominantly contains platinum. The heat-generating element 102 has a heat-generating portion 102a positioned on a forward end side thereof, and a pair of heater lead portions 102b extending from the heat-generating portion 102a along the longitudinal direction of the first substrate 101. Ends of the heater lead portions 102b are electrically connected to the respective electrode terminal portions 120 through heater-side through-holes 101a formed in the first substrate 101.

The oxygen-concentration detection cell 130 includes a first solid electrolyte layer 105, a first electrode 104 formed on one side of the first solid electrolyte layer 105, and a second electrode 106 formed on the other side of the first solid electrolyte layer 105. The first electrode 104 has a first electrode portion 104a and a first lead portion 104b, which extends from the first electrode portion 104a along the longitudinal direction of the first solid electrolyte layer 105. The second electrode 106 has a second electrode portion 106a and a second lead portion 106b, which extends from the second electrode portion 106a along the longitudinal direction of the first solid electrolyte layer 105.

The end of the first lead portion 104b is electrically connected to the corresponding electrode terminal portion 121 via a first through-hole 105a formed in the first solid electrolyte layer 105, a second through-hole 107a formed in an insulating layer 107 to be described later, a fourth through-hole 109a formed in a second solid electrolyte layer 109, and a sixth through-hole 111a formed in a protection layer 111. The end of the second lead portion 106b is electrically connected to the corresponding electrode terminal portion 121 via a third through-hole 107b formed in the insulating layer 107, a fifth through-hole 109b formed in the second solid electrolyte layer 109, and a seventh through-hole 111b formed in the protection layer 111.

The oxygen pump cell 140 includes the second solid electrolyte layer 109, a third electrode 108 formed on one side of the second solid electrolyte layer 109, and a fourth electrode 110 formed on the other side of the second solid electrolyte layer 109. The third electrode 108 has a third electrode portion 108a and a third lead portion 108b, which extends from the third electrode portion 108a along the longitudinal direction of the second solid electrolyte layer 109. The fourth electrode 110 has a fourth electrode portion 110a and a fourth lead portion 110b, which extends from the fourth electrode portion 110a along the longitudinal direction of the second solid electrolyte layer 109.

The end of the third lead portion 108b is electrically connected to the corresponding electrode terminal portion 121 via the fifth through-hole 109b formed in the second solid electrolyte layer 109 and the seventh through-hole 111b formed in the protection layer 111. The end of the fourth lead portion 110b is electrically connected to the corresponding electrode terminal portion 121 via an eighth through-hole 111c formed in the protection layer 111. Notably, the second lead portion 106b and the third lead portion 108b have the same electrical potential via the third through-hole 107b.

The first solid electrolyte layer 105 and the second solid electrolyte layer 109 are of a partially-stabilized-zirconia sintered body which is formed by adding yttria (Y₂O₃) or calcia (CaO) serving as a stabilizer to zirconia (ZrO₂).

The heat-generating element 102, the first electrode 104, the second electrode 106, the third electrode 108, the fourth electrode 110, the electrode terminal portions 120, and the electrode terminal portions 121 can be formed of a platinum group element. Platinum group elements which are preferred as materials for these members include Pt, Rh, and Pd. These platinum group elements can be used singly or in combination.

More preferably, in view of heat resistance and oxidation resistance, Pt is used in a predominant amount to form the heat-generating element 102, the first electrode 104, the second electrode 106, the third electrode 108, the fourth electrode 110, the electrode terminal portions 120, and the electrode terminal portions 121. Further preferably, the heat-generating element 102, the first electrode 104, the second electrode 106, the third electrode 108, the fourth electrode 110, the electrode terminal portions 120, and the electrode terminal portions 121 contain a ceramic component in addition to a main component of a platinum group element.

The insulating layer 107 is formed between the oxygen pump cell 140 and the oxygen-concentration detection cell 130. The insulating layer 107 includes an insulating portion 114 and diffusion-controlling portions 115. A gas detection chamber 107c is formed in the insulating portion 114 of the insulating layer 107 at a position corresponding to the second electrode portion 106a and the third electrode portion 108a. The gas detection chamber 107c communicates with the ambient atmosphere along the lateral direction of the insulating layer 107. In the communication region of the insulating layer 107, the diffusion-controlling portions 115 are provided so as to implement gas diffusion at a predetermined flow rate between the ambient atmosphere and the gas detection chamber 107c.

No particular limitation is imposed on the insulating portion 114, so long as the insulating portion 114 is of an electrically insulative ceramic sintered body. Examples of such a ceramic sintered body include oxide ceramics, such as alumina and mullite. The diffusion-controlling portions 115 are of a porous body of alumina. The diffusion-controlling portions 115 control the flow rate of a gas-to-be-measured when the gas flows into the gas detection chamber 107c.

The protection layer 111 is formed on the surface of the second solid electrolyte layer 109 such that the fourth electrode 110 is sandwiched therebetween. The protection layer 111 includes a porous electrode protector 113a and a reinforcement 112. The electrode protector 113a covers the fourth electrode portion 110a and is fitted into a through-hole 112a formed in the reinforcement 112, which covers the fourth lead portion 110b.

As shown in FIG. 1, the circuit board 20 is positioned above the upper end of the sensor element 10 and is disposed such that its planar surface is substantially perpendicular to the longitudinal direction (axial direction) of the sensor element 10. The circuit board 20 is electrically connected to the electrode terminal portions 120 and 121 of the sensor element 10 via the terminals 50 and is electrically connected to an electronic control unit (hereinafter, referred to as the “ECU”) 99, which controls an automobile, via electric wires 90.

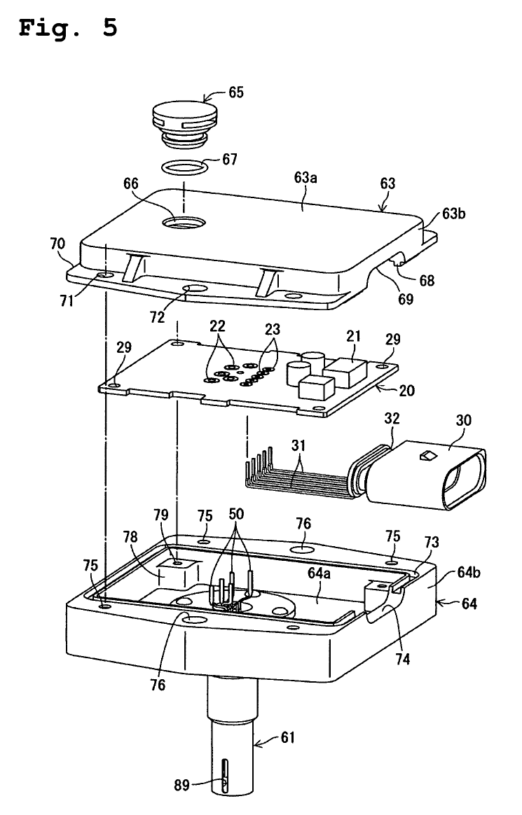

As shown in FIG. 5, various electronic components for processing signals; for example, an integrated circuit (IC), a resistor, and a capacitor, are mounted on the front surface of the circuit board 20. For example, the electronic components constitute a signal conversion circuit 21 which converts an analog sensor signal, which varies with an electrical characteristic of the sensor element 10, to a digital signal. The digital signal generated in the signal conversion circuit 21 is output to the ECU 99. On the basis of the digital signal input to the ECU 99, the ECU 99 performs processing for determining variation of concentration of a gas-to-be-measured. Also, a heater control circuit (not shown) for controlling the amount of supply of power to the heater 200 (see FIG. 8) is provided on the front surface of the circuit board 20.

As shown in FIGS. 1 and 3 to 5, five terminals 50 are provided. Three of the five terminals 50 serve as electric junctions between the electrode terminal portions 121 of the sensor element 10 and the signal conversion circuit 21 of the circuit board 20. Two of the five terminals 50 serve as electric junctions between the electrode terminal portions 120 of the sensor element 10 and the heater control circuit. The terminals 50 are strip-like lead terminals and extend in the axial direction. The first ends (lower ends in the drawings) of the terminals 50 are connected to the respective electrode terminal portions 120 and 121 by soldering, whereas the second ends (upper ends in the drawings) of the terminals 50 are inserted through respective through-holes 22 of the circuit board 20 from the back-surface side (from underneath) of the circuit board 20 and are connected to the signal conversion circuit 21 and the heater control circuit by soldering on the front-surface side of the circuit board 20. The through-holes 22 collectively correspond to the “terminal insertion hole” appearing in the appended claims.

A tubular connector 30 is disposed at a lateral end of the circuit board 20 and opens laterally outward. Five connector pins 31 are juxtaposed within and project from the connector 30. The connector pins 31 extend outwardly from the rear end of the connector 30; are cranked toward the back-surface side of the circuit board 20; are inserted through respective through-holes 23 of the circuit board 20 from the back-surface side of the circuit board 20; and are connected to the signal conversion circuit 21 and the heater control circuit by soldering on the front-surface side of the circuit board 20.

As shown in FIG. 1, the connector 30 is engaged with a mating connector 95, whereby the connector pins 31 are electrically connected to respective mating connector pins 96 of the mating connector 95. The mating connector pins 96 are connected to ends of the respective electric wires 90, which extend to the ECU 99.

As mentioned above, processing means having the signal conversion circuit 21 and the heater control circuit is provided on the front-surface side of the circuit board 20, whereas the sensor element 10 is disposed on the back-surface side (opposite the front-surface side) of the circuit board 20. Thus, the sensor element 10 and the processing means are disposed apart from each other, thereby preventing heat generated by the heat-generating portion 102a of the sensor element 10 from affecting the processing means.

Furthermore, the terminals 50 are joined to the signal conversion circuit 21 and the heater control circuit on the front-surface side of the circuit board 20. Thus, the connections between the terminals 50 and the processing means are disposed apart from the sensor element 10, thereby preventing heat generated by the heat-generating portion 102a of the sensor element 10 from affecting the connections.

Next, the casing 60 will be described. The casing 60 is an aluminum die casting and includes an axially extending slender, tubular detecting-portion housing 61, which encloses the sensor element 10, and a circuit-board housing 62, which lies along a direction substantially perpendicular to the axial direction of the sensor element 10 and encloses the circuit board 20. The circuit-board housing 62 includes an upper cover 63 and a lower cover 64, which are vertically assembled together.

As shown in FIG. 5, the upper cover 63 includes a cover portion 63a having a substantially rectangular shape and a descending portion 63b, which descends from four sides of the cover portion 63a.

The cover portion 63a has a circular vent hole 66, into which a vent member 65 is fitted. As shown in FIG. 1, the vent member 65 includes a filter 65a, which has air permeability and resistance to passage of water, and a cap 65b, in which the filter 65a is provided. A first seal ring 67 is provided between the cap 65b and the cover 63.

The filter 65a permits the passage of air and water vapor from the interior of the circuit-board housing 62 to the exterior of the circuit-board housing 62, but does not permit the passage of water from the exterior of the circuit-board housing 62 to the interior of the circuit-board housing 62. A material for the filter 65a is, for example, GORE-TEX (registered trademark). The present embodiment holds the possibility that water might enter the circuit-board housing 62 through the connector 30 or the like. Water which has entered the circuit-board housing 62 may humidify the interior of the circuit-board housing 62. However, since the filter 65a covers the vent hole 66, which extends through the cover portion 63a, water vapor is discharged to the exterior of the cover portion 63a through the filter 65a. Thus, the interior of the circuit-board housing 62 does not become humid, thereby preventing the occurrence of a short circuit on the circuit board 20 or a like problem.

As shown in FIG. 5, the descending portion 63b has a projection 68, which is formed peripherally at the bottom end of the descending portion 63b in such a manner as to project downward. The descending portion 63b also has a first cutout 69, which is formed at one of two short sides of the descending portion 63b at a position corresponding to the connector 30 in such a manner as to open downward. Furthermore, the descending portion 63b has plate-like projecting rim portions 70, which are formed along its two long sides, respectively, of the descending portion 63b. Each of the projecting rim portions 70 has two first through-holes 71 formed at its longitudinal end portions and a second through-hole 72 formed at its longitudinally central portion.

The lower cover 64 as a whole is thicker than the upper cover 63. The lower cover 64 includes a bottom portion 64a having a substantially rectangular shape and an ascending portion 64b, which ascends from four sides of the bottom portion 64a. The ascending portion 64b has a groove 73, which is formed peripherally at the top end of the ascending portion 64b so as to receive the projection 68 of upper cover 63. The ascending portion 64b also has a second cutout 74, which is formed at one of two short sides of the ascending portion 64b at a position corresponding to the connector 30 in such a manner as to open upward. Furthermore, each of two long-side portions of the ascending portion 64b has a thickness corresponding to the projecting width of the projecting rim portion 70 and has two first reception holes 75 formed at its longitudinal end portions and a second reception hole 76 formed at its longitudinally central portion.

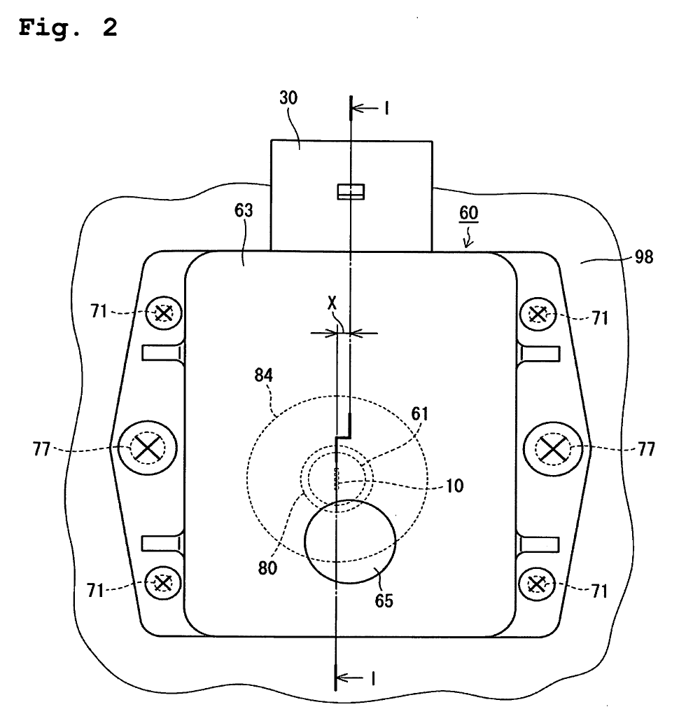

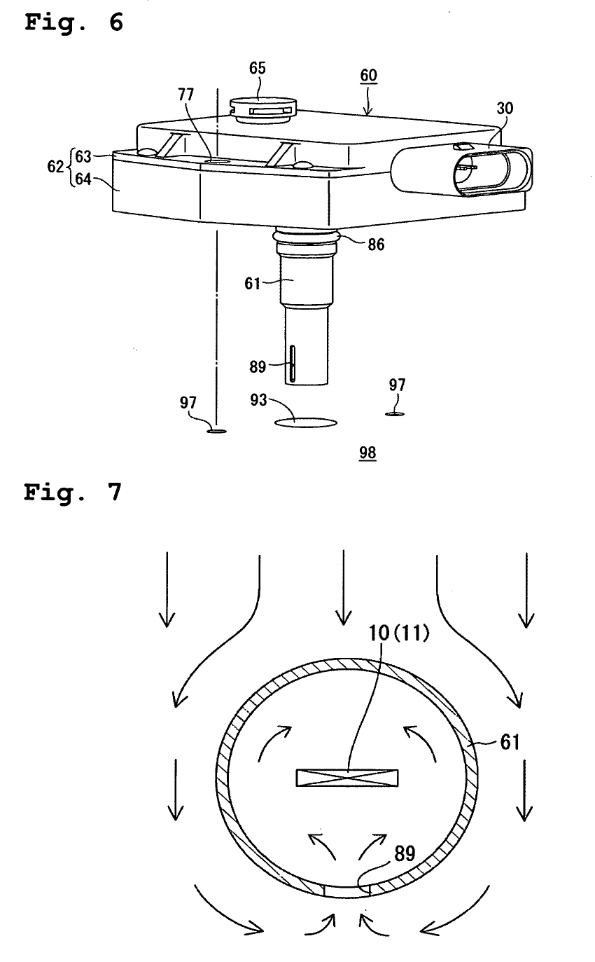

In assembling the upper cover 63 and the lower cover 64 together, when the top end of the ascending portion 64b and the bottom end of the descending portion 63b are butted against each other, the projection 68 is fitted into the groove 73, whereby the upper cover 63 and the lower cover 64 are positioned in relation to each other. When the top end of the ascending portion 64b and the bottom end of the descending portion 63b are butted against each other, the first through-holes 71 and the corresponding first reception holes 75 are aligned with each other. By means of fastening bolts which extend into the thus-aligned holes 71 and 75, the upper cover 63 and the lower cover 64 are fixed together. Similarly, the second through-holes 72 and the corresponding second reception holes 76 are aligned with each other. As shown in FIGS. 2 and 6, in mounting the gas sensor on an external object (an intake pipe 401 or a cylinder head 405, which will be described alter), the thus-aligned second through-holes 72 and second reception holes 76 are aligned with corresponding engagement holes 97 formed in a mounting surface 98 of the external object. By means of fastening bolts which extend into the thus-aligned second through-holes 72, second reception holes 76, and engagement holes 97, the gas sensor is fixedly mounted on the external object. Notably, the second through-holes 72 and the second reception holes 76 collectively correspond to the “attachment portion” appearing in the appended claims and are hereinafter referred to as the attachment portions 77.

Furthermore, when the top end of the ascending portion 64b and the bottom end of the descending portion 63b are butted against each other, the first cutout 69 is engaged from above with a groove 32 which is formed in the outer peripheral surface of the connector 30 as shown in FIG. 5, while the second cutout 74 is engaged from underneath with the groove 32. By this procedure, the connector 30 is fixedly held between the upper cover 63 and the lower cover 64. As shown in FIG. 1, a seal member 35 is peripherally provided on the bottom of the groove 32 of the connector 30. The seal member 35 provides a seal between the connector 30 and the casing 60.

As shown in FIG. 5, four support portions 78 for supporting the circuit board 20 stand at respective inner corners of the lower cover 64. The support portions 78 have respective third reception holes 79 formed in their top ends. When the circuit board 20 is supported on the support portions 78, the third reception holes 79 are aligned with corresponding third through-holes 29 formed at four corners of the circuit board 20. By means of fastening bolts which extend into the thus-aligned holes 29 and 79, the circuit board 20 is fixed to the lower cover 64 at a position located above the bottom portion 64a.

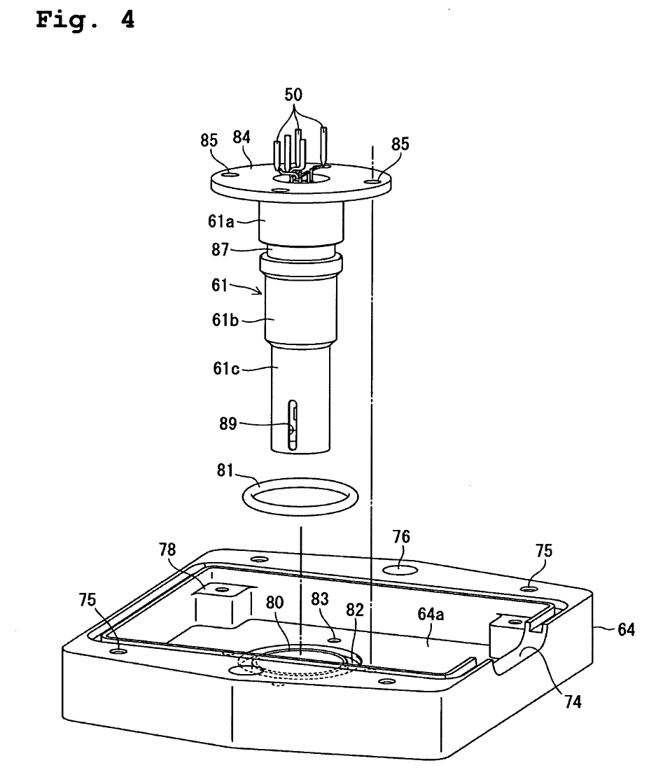

As shown in FIG. 4, the bottom portion 64a of the lower cover 64 has a circular attachment hole 80 formed therein. The detecting-portion housing 61 is inserted from above through the attachment hole 80 for attachment to the lower cover 64. The attachment hole 80 is eccentrically positioned in relation to the center of the bottom portion 64a. Also, the bottom portion 64a has an annular groove 82, which is formed around the attachment hole 80 and into which a second seal ring 81 is fitted. Furthermore, the bottom portion 64a has fourth reception holes 83, which are formed around the annular groove 82 and are circumferentially apart from one another.

The detecting-portion housing 61 assumes the form of a closed-bottomed, slender, circular tube. The detecting-portion housing 61 has a flange portion 84, which extends radially outward from the upper open end of the detecting-portion housing 61. The flange portion 84 has fourth through-holes 85, which are formed circumferentially apart from one another. When the detecting-portion housing 61 is inserted through the attachment hole 80 of the lower cover 64, the fourth through-holes 85 and the corresponding fourth reception holes 83 are aligned with each other. By means of fastening bolts which extend into the thus-aligned holes 83 and 85, the detecting-portion housing 61 is fixed to the lower cover 64. At this time, the second seal ring 81 provides a seal between the flange portion 84 and the lower cover 64.

As shown in FIG. 1, the detecting-portion housing 61 includes an upper portion 61a having a thick wall, an intermediate portion 61b having an intermediately thick wall, and a lower portion 61c having a thin wall. As shown in FIG. 4, the upper portion 61a of the detecting-portion housing 61 has an outer circumferential groove 87, which is formed in the outer circumferential surface of the upper portion 61a and into which a third seal ring 86 is fitted. When the attachment portions 77 are attached to an external object, the third seal ring 86 provides a seal between the external object and the detecting-portion housing 61.

A stepped portion 88 is provided on the inner circumferential surface of the intermediate portion 61b of the detecting-portion housing 61. The inside diameter of the detecting-portion housing 61 as measured below the stepped portion 88 is smaller than that as measured above the stepped portion 88. A holder member 41 for holding the sensor element 10 is butted from above against the stepped portion 88, whereby the sensor element 10 is held within the detecting-portion housing 61 in such a condition as to be vertically positioned. The holder member 41 is a ring member formed of alumina ceramic and is externally fitted to the sensor element 10 at a position located above the detecting portion 11.

Furthermore, the lower portion 61c of the detecting-portion housing 61 has a vertically extending slit-like gas communication hole 89. The sensor element 10 is housed within the detecting-portion housing 61 such that the detecting portion 11 of the sensor element 10 faces the gas communication hole 89 from inside. When the lower portion 61c of the detecting-portion housing 61 is exposed to a gas-to-be-measured which is flowing through a gas flow path, the gas-to-be-measured is introduced into the detecting-portion housing 61 through the gas communication hole 89. The introduced gas-to-be-measured comes into contact with the detecting portion 11 of the gas sensor element 10. The wall of the detecting-portion housing 61 is blind except for the gas communication hole 89.

A hardened section 42 is provided in a portion of the clearance between the detecting-portion housing 61 and the sensor element 10 which is located above the holder member 41, for transmitting heat from the heat-generating portion 102a (see FIG. 8) to the casing 60 to thereby release heat to the exterior of the casing 60. The hardened section 42 is of a material having high thermal conductivity. For example, alumina, more specifically alumina cement, can be used to form the hardened section 42. Since alumina exhibits excellent thermal conductivity, the hardened section 42 of alumina can efficiently conduct heat from the heat-generating portion 102a to the casing 60 for releasing heat to the external object and to the ambient atmosphere. Also, since alumina is electrically nonconductive, the hardened section 42 of alumina does not electrically interfere with the sensor element 10, thereby enabling the gas sensor to properly function. In the case where the hardened section 42 is of alumina cement, the hardened section 42 can be formed by pouring a slurry of alumina cement into the clearance between the detecting-portion housing 61 and the sensor element 10. Thus, workability is excellent, and formation of a clearance, i.e., a gap, between the inner surface of the detecting-portion housing 61 and the outer surface of the sensor element 10 can be prevented. The holder member 41 and the hardened section 42 collectively correspond to the “heat transfer section” appearing in the appended claims.

Furthermore, a seal section 43 is provided in a portion of the clearance between the detecting-portion housing 61 and the sensor element 10 which is located near the circuit board 20 and above the holder member 41 and the hardened section 42. The seal section 43 airtightly seals an upper end portion of the sensor element 10. Preferably, the seal section 43 is of an insulating resin having heat resistance. For example, epoxy resin or fluorine-containing rubber can be used to form the seal section 43. Also, both of epoxy resin and fluorine-containing rubber may be used to form the seal section 43. By means of the seal section 43 sealing an upper end portion of the sensor element 10, the movement of water from the detecting-portion housing 61 to the circuit-board housing 62 can be prevented, whereby contact of water with the circuit board 20 can be prevented. Particularly, in the case where the hardened section 42 is of alumina cement, pores formed in the hardened section 42 may form a water channel to the detecting portion 11; thus, the provision of the seal section 43 above the hardened section 42 is desirable. Also, by virtue of the holder member 41 and the hardened section 42, a region which is closer to the circuit board 20 than the holder member 41 and the hardened section 42 is unlikely to assume high temperature; therefore, the seal section 43, which is provided in the region, is unlikely to deteriorate. Since the seal section 43 seals the connections between the terminals 50 and the electrode terminal portions 120 and 121, the connections are ensured of electrical insulation.

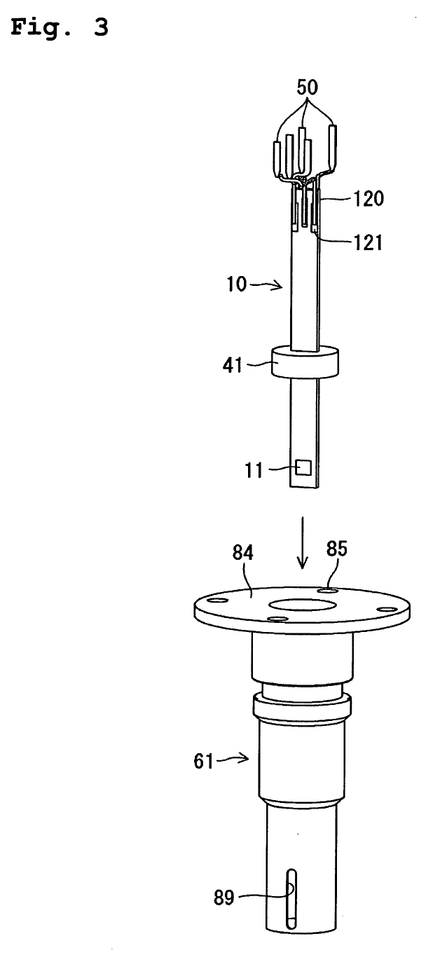

Next, a method of manufacturing the above-described gas sensor will be described. First, as shown in FIG. 3, first end portions of the terminals 50 are connected by soldering to the electrode terminal portions 120 and 121, respectively, of the sensor element 10. The holder member 41 is externally fitted to an intermediate portion of the sensor element 10. Subsequently, the sensor element 10 is inserted into the detecting-portion housing 61 from the rear end opening of the detecting-portion housing 61 until the holder member 41 rests on the stepped portion 88, as shown in FIG. 1. The sensor element 10 is rotated about the axis so that the detecting portion 11 faces the gas communication hole 89.

A slurry of alumina cement is poured into the detecting-portion housing 61 from the rear end opening of the detecting-portion housing 61 and thus is layered on the holder member 41. After the alumina cement is hardened and becomes the hardened section 42, epoxy resin or the like is charged into the detecting-portion housing 61 so as to form the seal section 43 on the hardened section 42, thereby sealing a second end portion of the sensor element 10. By this procedure, the entire sensor element 10 is fixedly housed within the detecting-portion housing 61, while second end portions of the terminals 50 project upward.

Next, as shown in FIG. 4, the detecting-portion housing 61 which houses the sensor element 10 is attached to the circuit-board housing 62. Before starting the attaching work, the second seal ring 81 is fitted into the annular groove 82 of the lower cover 64. The detecting-portion housing 61 is inserted from above through the attachment hole 80 of the lower cover 64 until the flange portion 84 is seated on the bottom portion 64a of the lower cover 64. Next, the detecting-portion housing 61 is rotated about the axis until the fourth through-holes 85 are aligned with the corresponding fourth reception holes 83. Bolts are fastened into the thus-aligned fourth-through holes 85 and fourth reception holes 83, thereby joining the detecting-portion housing 61 and the lower cover 64 together. At this time, the detecting-portion housing 61 is uniquely positioned in relation to the lower cover 64.

Subsequently, as shown in FIG. 5, the groove 32 of the connector 30 is engaged with the second cutout 74 of the lower cover 64. In this state, the circuit board 20 is placed from above in the lower cover 64. By this procedure, second end portions of the terminals 50 are inserted from underneath into the respective through-holes 22; similarly, end portions of the connector pins 31 are inserted from underneath into the respective through-holes 23; and the four corners of the circuit board 20 rest on the top ends of the respective support portions 78. Next, bolts are fastened into the aligned third through-holes 29 and third reception holes 79, thereby joining the circuit board 20 and the lower cover 64 together. Furthermore, projecting end portions of the terminals 50 and projecting end portions of the connector pins 31 are fixed by soldering to the front surface of the circuit board 20.

Subsequently, the upper cover 63 is placed on the lower cover 64. Bolts are fastened into the aligned first through-holes 71 and first reception holes 75, thereby joining the upper cover 63 and the lower cover 64 together. By this procedure, the connector 30 is held between the first cutout 69 of the upper cover 63 and the second cutout 74 of the lower cover 64. In the course of these procedures, the vent member 65 is fitted into the vent hole 66 of the upper cover 63.

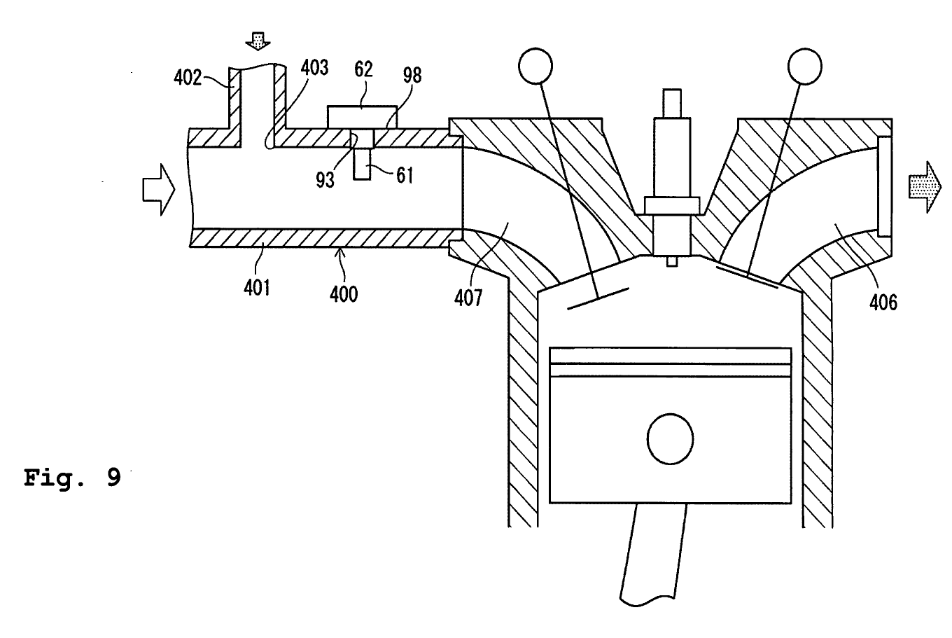

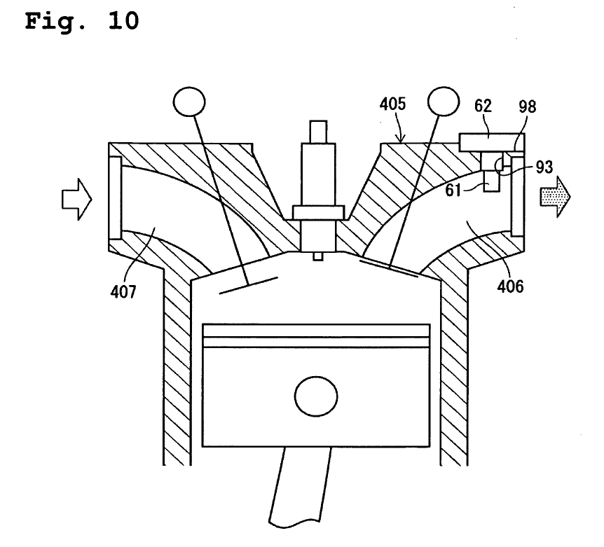

The thus-completed gas sensor can be used selectively either in a mounting mode 1 shown in FIG. 9 or in a mounting mode 2 shown in FIG. 10.

As shown in FIG. 9, the mounting mode 1 is as follows. An end of an EGR pipe 402 is connected to the intake pipe 401 of an intake path 400 for recirculating a portion (hereinafter, referred to as EGR gas) of exhaust gas of an engine into the intake pipe 401. The gas sensor is mounted downstream of an EGR gas inlet 403, through which the EGR pipe 402 communicates with the intake pipe 401. Specifically, the circuit-board housing 62 is placed on the outer circumferential surface of the intake pipe 401, while the detecting-portion housing 61 projects into a flow path in the intake pipe 401. In this case, the gas sensor detects a gas-to-be-measured contained in a mixed gas of EGR gas and intake gas.

As shown in FIG. 10, in the mounting mode 2, the gas sensor is mounted on the cylinder head 405. Specifically, the circuit-board housing 62 is placed on the outer wall of the cylinder head 405, while the detecting-portion housing 61 projects into a flow path in an exhaust port 406 of the cylinder head 405. In this case, the gas sensor detects a gas-to-be-measured contained in post-combustion gas.

As shown in FIG. 6, the mounting surface 98 in either case of the mounting modes 1 and 2 has a detection hole 93, which can be aligned with the attachment hole 80, as well as the engagement holes 97, which are located on opposite sides of the detection hole 93 and can be aligned with the respective attachment portions 77.

In the mounting modes 1 and 2, the temperature around the location where the gas sensor is installed becomes lower than that in the case where the gas sensor is mounted on an exhaust pipe. Thus, thermal influence on the connections between the sensor element 10 and the terminals 50, on the connections between the terminals 50 and the processing means, and on the processing means is lessened, thereby protecting the connections and the processing means from thermal influence.

By virtue of heat radiation from the cylinder head 405, and a cooling mechanism provided for the cylinder head 405, the temperature of the cylinder head 405 is lowered. Thus, the mounting mode 2 lessens thermal influence on the connections between the sensor element 10 and the terminals 50, on the connections between the terminals 50 and the processing means, and on the processing means, although the degree of lessening the thermal influence is smaller than in the case of the mounting mode 1 in which the gas sensor is mounted on the intake path 400.

Next will be described a method and structure of mounting the gas sensor on the intake pipe 401 and on the cylinder head 405. Prior to the mounting of the gas sensor, the third seal ring 86 is fitted into the outer circumferential groove 87 of the detecting-portion housing 61.

As shown in FIG. 1, when the detecting-portion housing 61 is inserted through the detection hole 93, the bottom surface of the circuit-board housing 62 is seated on the mounting surface 98, and the lower portion 61c of the detecting-portion housing 61 is projected into a gas flow path.

In this case, when the gas communication hole 89 of the detecting-portion housing 61 faces the downstream side of the flow path as shown in FIG. 7, the attachment portions 77 and the corresponding engagement holes 97 are aligned with each other as shown in FIG. 6. Thus, by means of fastening bolts into the aligned second through-holes 72, second reception holes 76, and engagement holes 97 as shown in FIGS. 2 and 5, the gas sensor is fixedly mounted on the mounting surface 98.

As shown in FIG. 7, a gas flows along the detecting-portion housing 61 and enters the detecting-portion housing 61 from downstream through the gas communication hole 89. Then, the gas comes into contact with the detecting portion 11 in the detecting-portion housing 61, whereby a gas-to-be-measured contained in the gas is detected. Meanwhile, a portion of the wall of the detecting-portion housing 61 which faces the upstream side of the flow path is blind; therefore, the gas does not directly come into contact with the detecting portion 11 from upstream.

Usually, the gas contains foreign matter, such as water, oil, and soot. However, the above-described configuration can prevent adhesion of foreign matter to the detecting portion 11, since foreign matter contained in the gas interferes with the wall of the detecting-portion housing 61 and then flows downstream in a flow of the gas. As a result, a detection error is prevented.

By contrast, when the mounting of the gas sensor is attempted with the gas communication hole 89 of the detecting-portion housing 61 facing the upstream side of the flow path, alignment is not established between the attachment portions 77 and the engagement holes 97. Thus, bolts cannot be inserted into the engagement holes 97 through the second reception holes 76; therefore, the mounting of the gas sensor is disabled. In this case, the gas sensor is rotated to its proper mounting posture, and then the mounting of the gas sensor is redone.

As mentioned above, the gas sensor has an improper-attachment prevention structure functioning such that, when the gas communication hole 89 is properly oriented, the attachment of the attachment portions 77 to the engagement holes 97 is enabled, whereas, when the gas communication hole 89 is improperly oriented, the attachment of the attachment portions 77 to the engagement holes 97 is disabled. Thus, the mounting of the gas sensor with the gas communication hole 89 oriented improperly can be prevented. In this case, the improper-attachment prevention structure is implemented as shown in FIG. 2. Specifically, the center of the attachment hole 80, through which the detecting-portion housing 61 is inserted, is eccentrically positioned by X in FIG. 2 in relation to the center of a straight line connecting the centers of the two attachment portions 77 located on opposite sides of the attachment hole 80; similarly, the center of the detection hole 93, through which the detecting-portion housing 61 is inserted, is eccentrically positioned in relation to the center of a straight line connecting the centers of the two engagement holes 97 located on opposite sides of the detection hole 93.

Also, a portion (detecting-portion housing 61) of the gas sensor which encloses the sensor element 10 is slender, whereby the resistance of a flowing gas can be lessened. Furthermore, since the circuit-board housing 62 lies along the mounting surface 98 of an external object and does not externally project greatly, the gas sensor can avoid interference with peripheral components.

According to the gas sensor of the present embodiment, the casing 60 houses together the sensor element 10 and the circuit board 20, on which is mounted the processing means for processing an output signal from the sensor element 10, thereby eliminating the need to provide the processing means in the ECU 99 of a vehicle. This enhances the degree of freedom of design of the ECU 99 and expands the range of options in use of the ECU 99. Also, in addition to the casing 60 made of metal shielding the sensor element 10, the circuit board 20, and the terminals 50, an analog signal line, which conventionally is laid between the sensor element 10 and the ECU 99, is not employed. This provides a structure that is less susceptible to electric noise, thereby improving electrical reliability. Furthermore, in contrast to a conventional gas sensor, at the time of mounting of the gas sensor, the gas sensor is not rotatable about the axis. Therefore, in association with the procedure of mounting, the sensor element 10 can be circumferentially positioned.

The present invention is not limited to the above-described embodiment, but may be modified as appropriate without departing from the gist of the invention.

For example, the attachment portions 77 may be attached to the external wall of the cylinder head 405 such that the detecting portion 11 projects into the flow path of an intake port 407 of the cylinder head 405. Also, the sensor element 10 may not have the heater 200, so that the circuit board 20 does not include the heater control circuit.

According to the above-described embodiment, soldering is used to connect the electrode terminal portions 120 and 121 and the first end portions of the terminals 50. However, the present invention is not limited thereto. For example, brazing or welding may be used. Furthermore, the electrode terminal portions 120 and 121 may be mechanically connected to the terminals 50 through an upward sliding motion of the sensor element 10.

According to the above-described embodiment, the terminals 50 are inserted through the through-holes 22 of the circuit board 20 from the back-surface side and are connected to the signal conversion circuit 21 and to the heater control circuit by soldering on the front-surface side of the circuit board 20. However, the present invention is not limited thereto. The terminals 50 may be connected to the signal conversion circuit 21 and to the heater control circuit by soldering on the back-surface side of the circuit board 20, without providing the through-holes 22 in the circuit board 20.

According to the above-described embodiment, the holder member 41, the hardened section 42, and the seal section 43 are provided in the region of the upper and intermediate portions 61a and 61b of the detecting-portion housing 61. However, the present invention is not limited thereto. The holder member 41, the hardened section 42, and the seal section 43 may be provided only in the intermediate portion 61b of the detecting-portion housing 61. Alternatively, the hardened section 42 and the seal section 43 may be provided in the upper portion 61a (i.e., the holder member 41 and the hardened section 42 are provided apart from each other).

The above-described embodiment employs the sensor element 10 having the oxygen pump cell 140 and the oxygen-concentration detection cell 130. However, the present invention is not limited thereto. A sensor element for use in a λ sensor or a sensor element for use in a limiting-current-type sensor may be employed.

What is claimed is:

1. A gas sensor comprising:
a sensor element comprising a solid electrolyte layer, a pair of electrodes formed on the solid electrolyte layer, and a detecting portion for detecting a gas-to-be-measured;
a circuit board having processing means mounted thereon for processing an output signal from the sensor element;
a terminal serving as an electric junction between the detecting portion of the sensor element and the processing means of the circuit board; and
a metal casing housing the sensor element, the circuit board, and the terminal, said metal casing having an attachment portion for attachment to an external object.

2. A gas sensor according to claim 1, wherein
the detecting portion is located on a first-end side of the sensor element with respect to a longitudinal direction of the sensor element;
the circuit board is located on a second-end side of the detecting portion opposite to the first end-side with respect to the longitudinal direction;
the circuit board is disposed along a direction generally perpendicular to the longitudinal direction of the sensor element; and
the casing has a detecting-portion housing which houses the detecting portion, and a circuit-board housing which houses the circuit board and where the attachment portion is provided.

3. A gas sensor according to claim 2, wherein a wall of the detecting-portion housing is configured such that a portion of the wall facing an upstream side of a flow path through which the gas-to-be-measured flows is blind, and a portion of the wall facing a downstream side of the flow path has a gas communication hole for allowing the gas-to-be-measured to communicate with the detecting portion.

4. A gas sensor according to claim 3, wherein the attachment portion has an improper attachment prevention structure that allows said gas sensor to be attached relative to a flow path only when the gas communication hole faces the downstream side of the flow path.

5. A gas sensor according to any one of claims 2 to 4, wherein:
the sensor element has a heater for heating the detecting portion, and
the processing means is disposed on a surface of the circuit board facing away from the sensor element.

6. A gas sensor according to any one of claims 2 to 4, wherein:
the sensor element has a heater for heating the detecting portion;
the circuit board has a terminal insertion hole through which the terminal is inserted; and
the processing means and the terminal are electrically connected to each other on a surface of the circuit board facing away from the sensor element.

7. A gas sensor according to any one of claims 2 to 4, wherein:
the sensor element has a heater for heating the detecting portion, and
a heat transfer section for transferring heat from the heater to the casing is provided in a clearance between the sensor element and the casing, the clearance being located on the second-end side of the detecting portion.

8. A gas sensor according to claim 7, wherein the heat transfer section is of alumina.

9. A gas sensor according to claim 7, wherein a seal section is provided in a clearance between the casing and the sensor element, the clearance being located the second-end side of the heat transfer section, so as to prevent passage of water through the clearance.

10. A gas sensor according to claim 2, wherein:
the circuit-board housing has a vent hole extending between the interior and the exterior of the circuit-board housing, and
a filter having air permeability and resistance to passage of water is provided in such a manner as to cover the vent hole.

11. A gas sensor according to claim 1, wherein the detecting portion is disposed within a intake path of an engine.

12. A gas sensor according to claim 11, wherein:
an EGR gas inlet opens into the intake path for introducing an EGR gas into the intake path, and
the detecting portion is disposed downstream of the EGR gas inlet.

13. A gas sensor according to claim 1, wherein the detecting portion is disposed within an intake path of a cylinder head or within an exhaust path of the cylinder head.

14. A gas sensor according to claim 2, wherein at least the circuit-board housing of the casing is formed of an aluminum-based or copper-based metallic material.

15. A gas sensor according to claim 2, wherein the casing is formed of an aluminum-based or copper-based metallic material.
